(19) United States
(12) Patent Application Publication
(10) Pub. No.: US 2014/0216112 A1
(43) Pub. Date: Aug. 7, 2014

(54) CABINET LOCK FOR PLATES OF DIFFERENT THICKNESSES

(71) Applicant: REAL LOCKS & SECURITY CO., LTD., New Taipei City (TW)

(72) Inventor: Ping-Jan YANG, New Taipei City (TW)

(73) Assignee: REAL LOCKS & SECURITY CO., LTD., New Taipei City (TW)

(21) Appl. No.: 13/826,579

(22) Filed: Mar. 14, 2013

(30) Foreign Application Priority Data
Feb. 7, 2013 (TW) 102202852

(51) Int. Cl. E05B 15/00; E05B 37/00

(52) U.S. Cl. CPC E05B 15/00; E05B 37/00
USPC 70/78

(57) ABSTRACT

A cabinet lock is disclosed. The cabinet lock includes an outer lock, an extension rod and an inner lock. The outer lock and the inner lock are separately disposed in two sides of the plate. The outer lock includes an outer decorating housing, a lock head and a lock post. The extension rod can optionally connect with the lock post and extend along an axis of the lock post. The inner lock includes an inner decorating housing, a lock barrel and a bolt. The lock post can optionally connect with the lock barrel through the extension rod. The lock head drives the lock post and the lock barrel for a telescopic movement of the bolt.

### BACKGROUND OF THE INVENTION

1. Field of the Invention

The present invention generally relates to a lock and, in particular to a cabinet lock for plates of different thicknesses.

2. Description of Related Art

Locks are widely used for people, such as key locks, cabinet locks, combination locks or keycard locks sensed by cards. In daily days, those kinds of locks provide a lot of convenience for users. Taking cabinet locks for example, cabinet locks are provided in specific places, like swimming pools or gyms. Users can place personal belongings in cabinets and lock it to prevent from being lost.

However, lengths of traditional locks structures are usually fixed and cannot be installed in doors of different thicknesses. In another words, custom doors need locks of different lengths for doors of different thicknesses. As a result, users will have inconvenience on purchase and installation.

In view of the above drawbacks, the Inventor proposes the present invention based on his expert knowledge and elaborate researches in order to solve the problems of related art.

### SUMMARY OF THE INVENTION

Accordingly, an object of the present invention is to provide a cabinet lock for plates of different thicknesses for facilitating manufacture and usage.

In order to achieve the object mentioned above, the present invention provides a cabinet lock for plates of different thicknesses. The cabinet lock installed in a plate has a first plate surface and a second plate surface opposite to the first plate surface. The cabinet lock includes an outer lock, an extension rod and an inner lock. The outer lock includes an outer decorating housing fixed on the first plate surface, a lock head disposed and inserted in the outer decorating housing and a lock post connected with the lock head. The extension rod is optionally connected with the lock post and extended along an axis of the lock post. The inner lock includes an inner decorating housing fixed on the second plate surface, a lock barrel disposed and inserted in the inner decorating housing and a bolt disposed in a lateral side of the lock barrel. Wherein, the lock post is optionally connected with the lock barrel through the extension rod, the lock head drives the lock post and the lock barrel for a telescopic movement of the bolt.

Comparing to the related art, the cabinet lock for plates of different thicknesses has an extension rod. The extension rod can optionally connect with the lock rod for adjusting the overall thickness of the cabinet lock. When the plate is thicker, the extension rod sleeves on the lock post for adjusting the cover length inserted the lock barrel. In the other hand, when the plate is thinner, the lock will not dispose an extension rod. The lock post is directly inserted in the lock barrel for installing on different thicknesses of the plate for manufacturing and usage of the cabinet lock easily.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is an application schematic view of a cabinet lock for plates of different thicknesses of the present invention;

FIG. 2 is a perspective exploded view of an outer lock and an extension rod of the present invention;

FIG. 3 is an assembly schematic view of an outer lock and an extension rod of the present invention;

FIG. 4 is an outer lock and an extension rod of the present invention;

FIG. 5 is an application schematic view of a cabinet lock for plates of different thicknesses of another embodiment of the present invention;

FIG. 6 is an application schematic view of a cabinet lock for plates of different thicknesses of further another embodiment of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

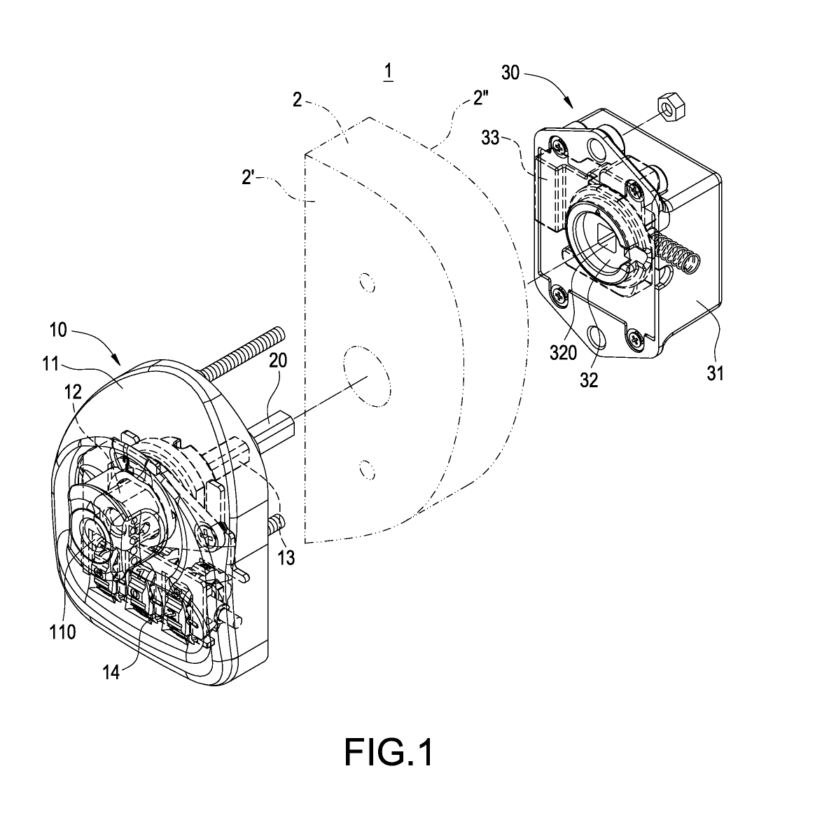

Please refer to FIG. 1, it depicts an application schematic view of a cabinet lock for plates of different thicknesses of the present invention. The present invention provides a cabinet lock 1 for different thicknesses installed in a plate 2. The plate 2 has a first plate surface 2′ and a second plate surface 2″ opposite to the first plate surface The cabinet lock 1 includes an outer lock 10, an extension rod 20 and an inner lock 30. The outer lock 10 and the inner lock 30 are disposed on two sides of the plate 2 respectively, and the extension rod 20 is disposed between the outer lock 10 and the inner lock 30.

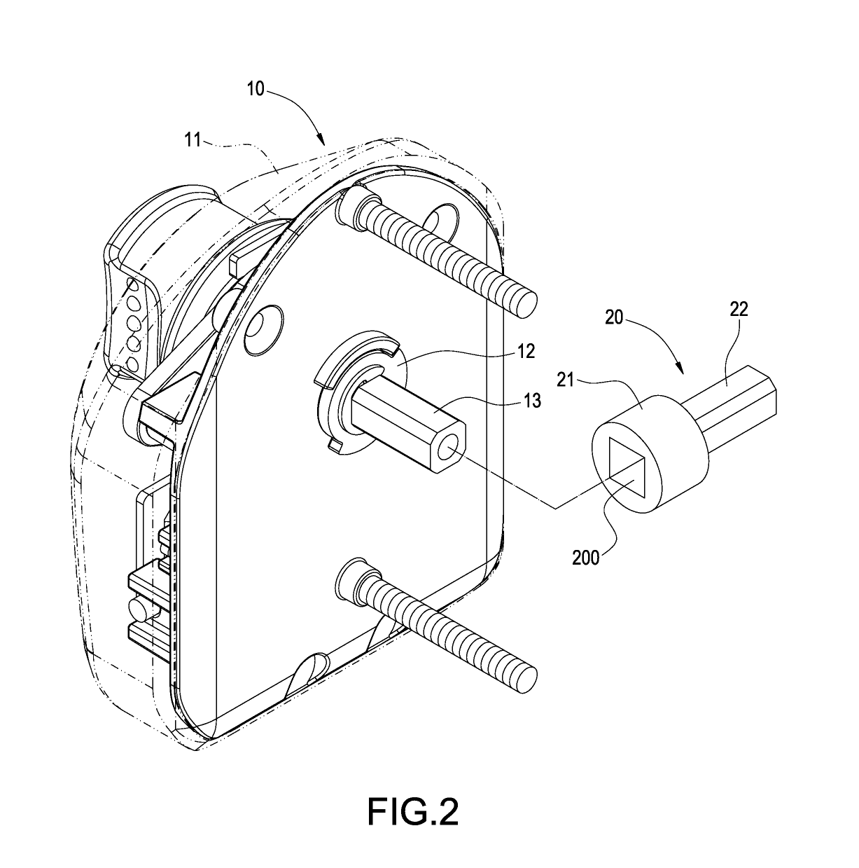

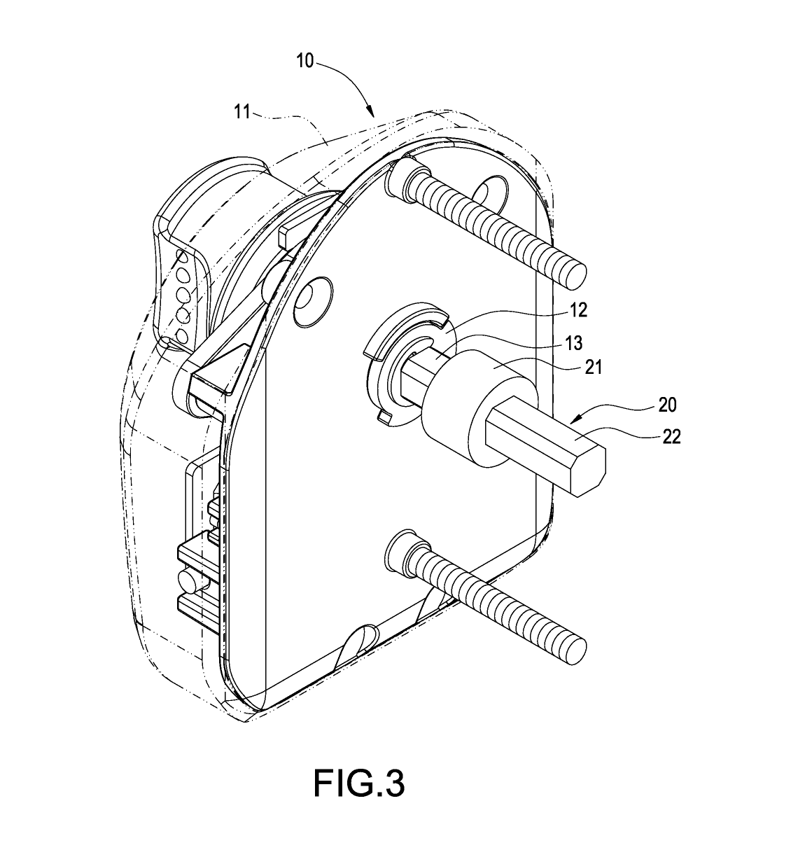

With referring to FIG. 2 to FIG. 4, they depict a perspective exploded view of an outer lock and an extension rod, an assembly schematic view of an outer lock and an extension rod and an outer lock and an extension rod of the present invention. The outer lock 10 includes an outer decorating housing 11 fixed on the first plate surface 2′, a lock head 12 disposed and inserted in the outer decorating housing 11 and a lock post 13 connected with the lock head 12. In an embodiment of the present invention, the outer decorating housing 11 has a fastening hole 110, and the lock head 12 is disposed corresponding to the position of the fastening hole 110. Moreover, the outer lock 10 further includes a combination lock 14, and the combination lock 14 is disposed in a lateral side of the lock head 12.

The extension rod 20 is optionally connected with the lock post 13 and extended along an axis of the lock post 13. In the present invention, the lock post 13 is a polygon column. One end of the extension rod 20 has a polygon hole 200 correspondingly, and the extension rod 20 is sleeved on the lock post 13. More particularly, the extension rod 20 has a head section 21 having the polygon hole 200 and an inserting section 22 extended from the head section 21. Preferably, the inserting section 22 is a polygon column for preventing it from rotational sliding.

The inner lock 30 includes an inner decorating housing 31 fixed on the second plate surface 2″ of the plate 2, a lock barrel 32 disposed and inserted in the inner decorating housing 31 and a bolt 33 disposed in a lateral side of the lock barrel 32. In an embodiment of the present invention, the lock barrel 32 has a slot 320, and the lock post 13 is inserted in the slot 320 through the extension rod 20.

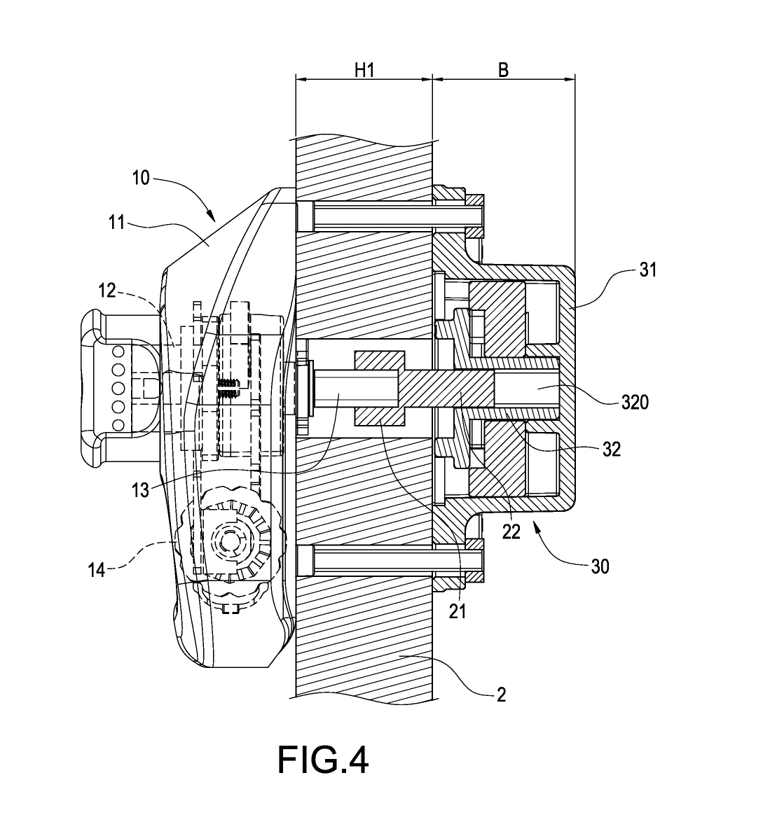

As shown in FIG. 4, the lock post 13 is optionally connected with the lock barrel 32 through the extension rod 20. The lock head 12 drives the lock post 13 and the lock barrel 32 for a telescopic movement of the bolt 33. That is the lock post 13 can directly connect and drive the lock barrel 32 for a telescopic movement of the bolt 33.

In the present invention, the thickness H1 of the plate 2 and the thickness B of the inner decorating housing 31 are not limited and which can be adjusted by demands.

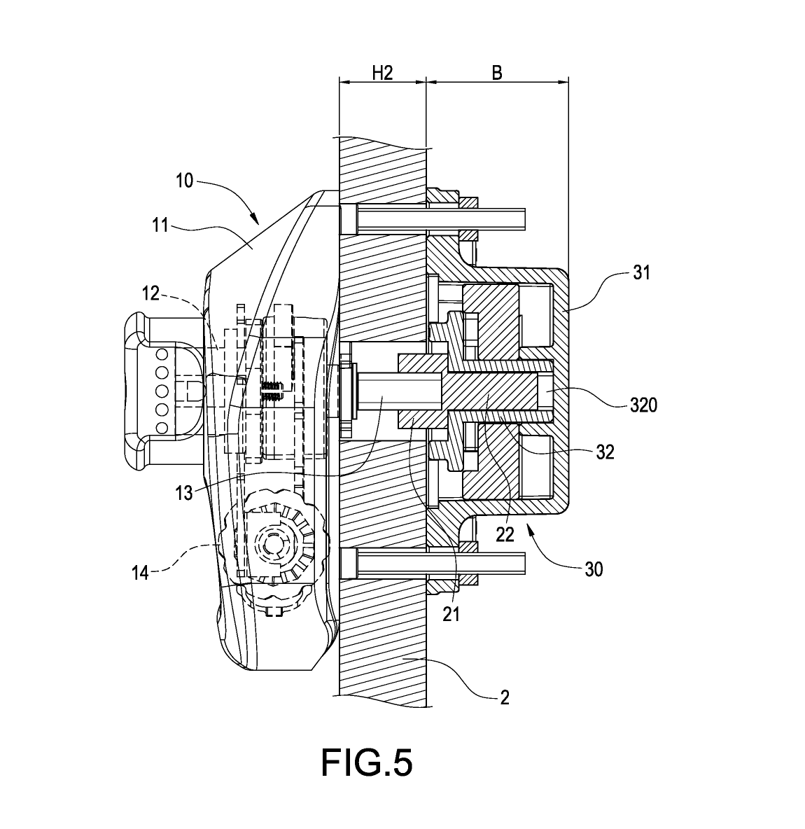

Please further referring to FIG. 5, it depicts an application schematic view of a cabinet lock for plates of different thicknesses of another embodiment of the present invention. The structure of the cabinet lock 1 in this shown embodiment is the same as the first embodiment. This embodiment differs from the first embodiment in the thickness of the plate 2. In the FIG. 5, the thickness H2 of the plate 2 is thinner than the thickness H1 of the plate 2. One end of the extension rod 20 is sleeved on the lock post 13 and the other end is inserted in a deeper location of the slot 320.

In the FIG. 4 and FIG. 5 of the present invention, the lock post 13 of the cabinet lock 1 is connected with the extension rod 20 for adjusting the overall thickness of the cabinet lock 1 in a lock 1 of different thicknesses of the plate 2.

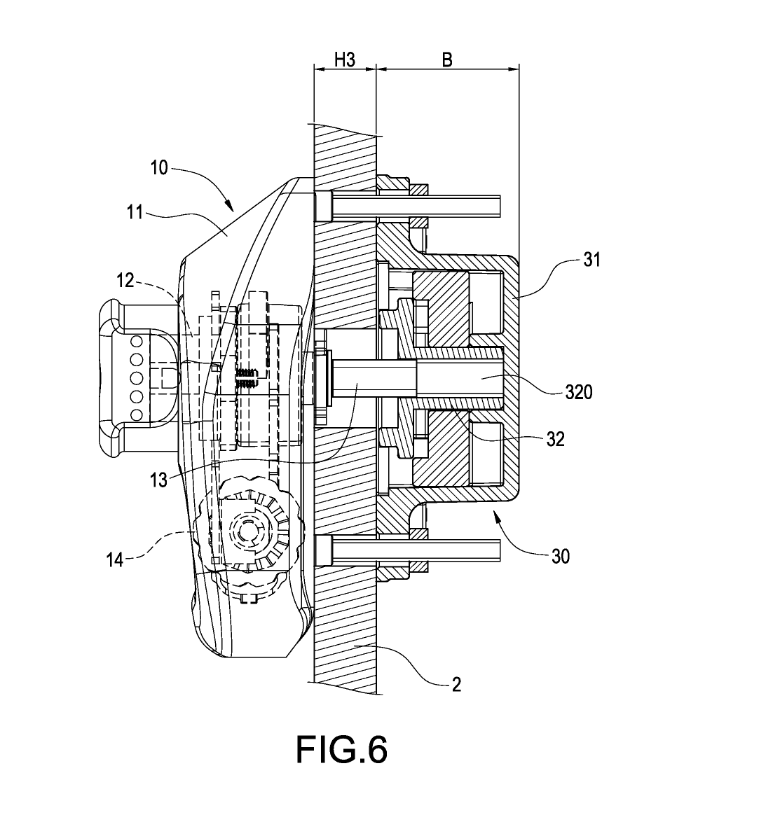

Please also refers to FIG. 6, it depicts an application schematic view of a cabinet lock for plates of different thicknesses of further another embodiment of the present invention. The cabinet lock 1 of this embodiment differs from the first embodiment in the thickness H3 of the plate 2. Another difference is that the cabinet lock 1 does not have the extension rod 20. In the embodiment shown in FIG. 6, the lock post 13 of the cabinet lock 1 is directly inserted in the slot 320.

In the FIG. 6 of the present invention, the lock post 13 of the cabinet lock 1 does not connect with the extension rod 20. The lock post 13 of the cabinet lock 1 is directly inserted on the lock barrel 32 for the cabinet lock 1 installed in a thinner plate 2.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A cabinet lock for plates of different thicknesses, the cabinet lock installed in a plate having a first plate surface and a second plate surface opposite to the first plate surface, the cabinet lock comprising:
an outer lock including an outer decorating housing fixed on the first plate surface, a lock head disposed and inserted in the outer decorating housing and a lock post connected with the lock head;
an extension rod optionally connected with the lock post and extended along an axis of the lock post; and
an inner lock including an inner decorating housing fixed on the second plate surface, a lock barrel disposed and inserted in the inner decorating housing and a bolt disposed in a lateral side of the lock barrel;
wherein, the lock post optionally connected with the lock barrel through the extension rod, the lock head driving the lock post and the lock barrel for a telescopic movement of the bolt.

2. The lock according to claim 1, wherein the outer lock further includes a combination lock disposed in a lateral side of the lock head.

3. The lock according to claim 1, wherein the lock post is a polygon column, one end of the extension rod has a polygon hole correspondingly, and the extension rod is sleeved on the lock post.

4. The lock according to claim 3, wherein the extension rod has a head section having the polygon hole and an inserting section extended from the head section.

5. The lock according to claim 4, wherein the inserting section is a polygon column.

6. The lock according to claim 1, wherein the outer decorating housing has a fastening hole, and the lock head is disposed corresponding to the position of the fastening hole.

7. The lock according to claim 1, wherein the lock barrel has a slot, the lock post is inserted in the slot through the extension rod.

8. The lock according to claim 1, wherein the lock barrel has a slot, and one end of the lock post is directly inserted in the slot.
